(19) United States
(12) Patent Application Publication
(10) Pub. No.: US 2016/0321210 A1
(43) Pub. Date: Nov. 3, 2016

(54) Electrical Isolation in Serial Communication

(71) Applicant: THE SILANNA GROUP PTY LTD, Eight Mile Plains (AU)

(72) Inventors: Virgilio T. Baterina, San Diego, CA (US); Yashodhan Vijay Moghe, Marsfield (AU)

(21) Appl. No.: 15/204,830

(22) Filed: Jul. 7, 2016

Related U.S. Application Data
(63) Continuation-in-part of application No. PCT/IB2014/067099, filed on Dec. 19, 2014.
(60) Provisional application No. 61/924,277, filed on Jan. 7, 2014.
(60) Provisional application No. 62/059,696, filed on Oct. 3, 2014.

(51) Int. Cl. G06F 13/42; G06F 13/38

(52) U.S. Cl. CPC G06F 13/4282; G06F 13/385

(57) ABSTRACT

First and second communication interfaces receive and transmit first and second communications through isolation circuitry at different communication frequency levels. In some embodiments, the first and second communication interfaces are USB 3 compatible, and the isolation circuitry is between the first and second communication interfaces and is compatible with all USB 3 communication modes.

### CROSS-REFERENCE TO RELATED APPLICATIONS

This patent application is a continuation-in-part of and claims the benefit of International Patent Application No. PCT/IB2014/067099 filed on Dec. 19, 2014, entitled “Electrical Isolation in Serial Communication”, which claims priority to U.S. Provisional Patent 62/059,696 filed Oct. 3, 2014 and also claims priority to U.S. Provisional Patent No. 61/924,277 filed Jan. 7, 2014; each of which are hereby incorporated by reference for all purposes.

### BACKGROUND

When electronic devices communicate with each other, electrical or galvanic isolation of the electronic devices is often essential to reduce or eliminate noise in the communication stream or to prevent malfunction of or damage to either electronic device due to a voltage spike from the other electronic device. It is necessary, therefore, to provide isolation circuitry within the communication path between the electronic devices. Various types of isolation circuitry have been created for various applications. Such isolation circuitry may involve capacitive, inductive or optical isolation techniques, in addition to a variety of other digital isolation solutions. An example capacitive isolation solution is provided in U.S. Pat. No. 9,299,655, which is assigned to the same assignee as the present invention and is incorporated herein by reference as if fully set forth herein.

Some examples of communication between electronic devices are defined by the various Universal Serial Bus (USB) standards, among many others. Example isolation circuitry for USB 2 communications is provided in US Patent Publication No. 2014/0211862, which is assigned to the same assignee as the present invention and is incorporated herein by reference as if fully set forth herein.

### SUMMARY

Some embodiments of the present invention enable isolation for electronic devices compatible with all communication modes defined by the USB 3 standard. Additionally, some embodiments are backwardly compatible with USB 2 standards. Furthermore, in some embodiments, the isolation is provided by a capacitive isolation solution.

Some embodiments of the present invention enable isolation between electronic devices that operate at two different communication frequency levels. For example, in some embodiments, the isolation circuitry may operate at both 10 Mbps and 5 Gbps communication frequencies.

Some embodiments involve an electronic circuit comprising first and second communication interfaces and isolation circuitry. The first and second communication interfaces are USB 3 compatible. The isolation circuitry is between the first and second communication interfaces. The isolation circuitry is compatible with all USB 3 communication modes.

Some embodiments involve an electronic circuit comprising first and second serial communication interfaces and isolation circuitry. The isolation circuitry is between the first and second serial communication interfaces. The isolation circuitry operates at two different communication frequency levels.

Some embodiments involve a method comprising: receiving a first serial communication at a first frequency; transmitting the first serial communication through isolation circuitry; receiving a second serial communication at a second frequency greater than the first frequency; and transmitting the second serial communication through the isolation circuitry. The isolation circuitry provides galvanic isolation at both the first and second frequencies.

### DESCRIPTION OF DRAWINGS

FIG. 1 is a simplified schematic diagram of an electronic system incorporating at least one embodiment of the present invention.

FIG. 2 is a simplified schematic diagram of another electronic system incorporating at least one embodiment of the present invention.

FIG. 3 is a simplified schematic diagram of USB 3 isolation circuitry for use in the electronic system shown in FIG. 1 in accordance with an embodiment of the present invention.

FIG. 4 is a simplified schematic diagram of USB 3 isolation circuitry in accordance with another embodiment of the present invention.

FIG. 5 is a simplified schematic diagram of USB 3 isolation circuitry in accordance with yet another embodiment of the present invention.

FIG. 6 is a simplified schematic diagram of another electronic system incorporating at least one embodiment of the present invention.

FIG. 7 is a simplified schematic diagram of another electronic system incorporating at least one embodiment of the present invention.

### DETAILED DESCRIPTION

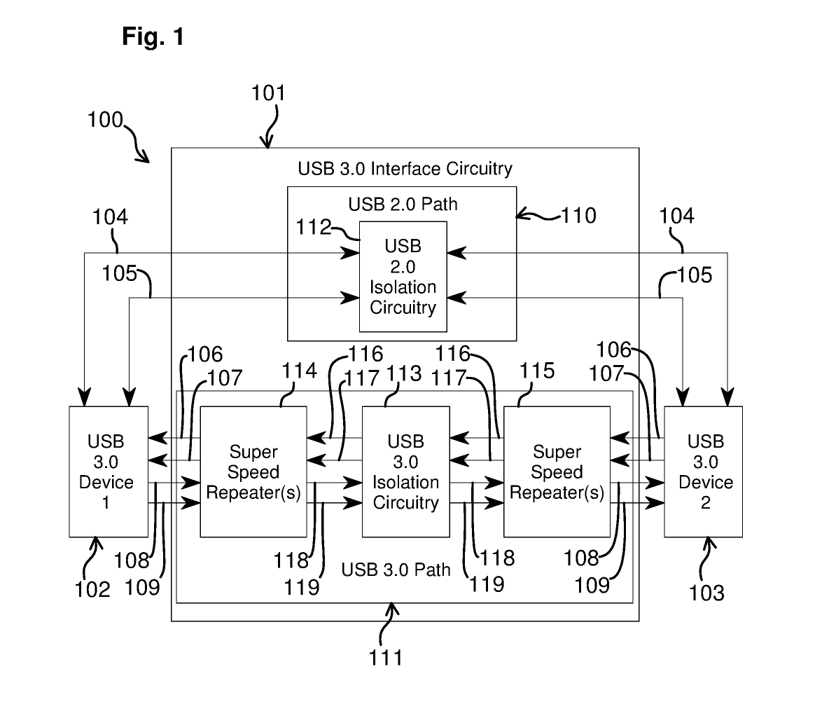

An electronic system 100 is shown in FIG. 1 in accordance with some embodiments of the present invention. The electronic system 100 generally includes USB 3 interface circuitry 101 connected between two USB 3 devices 102 and 103. The USB 3 interface circuitry generally enables all modes of USB 2 and 3 communication with isolation protection between the two USB 3 devices 102 and 103. The two USB 3 devices 102 and 103 may be any appropriate electronic devices that are compatible with the USB 3 standard.

The USB 2 standard evolved out of the earlier USB 1 standard and generally calls for communication modes between USB 2 compatible devices at speeds or frequencies of about 1.5 Mbps (low speed), 12 Mbps (full speed) and 480 Mbps (high speed). These communication modes are provided on two bi-directional communication lines. Two additional lines provide for power and ground between a host USB 2 device and an attached non-host USB 2 device that does not have a separate power supply.

The USB 3 standard (referring to versions 3.0 and 3.1), on the other hand, generally calls for communication modes between USB 3 compatible devices at speeds or frequencies of about 5 or 10 Gbps (super speed). These communication modes are provided on four low-voltage differential signaling (LVDS) uni-directional communication lines, an LVDS pair of lines in each direction, with each line at about 4.8 Gbps (rounded up to 5 Gbps in many descriptions thereof). Each LVDS pair, therefore, provides approximately 5 Gbps communication in one direction. The four uni-directional communication lines allow simultaneous 5-10 Gbps signaling upstream and downstream. The four uni-directional communication lines are known as the super speed interface. Additionally, the USB 3 standard further calls for backward compatibility with the USB 2 standard in case a USB 2 or USB 1 device is connected to a USB 3 device. The two bi-directional lines and the power and ground lines of USB 2 devices, therefore, are also included in USB 3 devices along with the four super speed uni-directional lines.

The two bi-directional USB 2 lines (104 and 105) and the four uni-directional USB 3 lines (106-109) are shown in FIG. 1 on each side of the USB 3 interface circuitry 101. The power and ground lines are not shown for simplicity.

The USB 3 interface circuitry 101 generally includes circuitry for a USB 2 communication path 110 and a USB 3 communication path 111. FIG. 1 thus shows the conceptual breakdown of the USB 3 isolation function into two sub-functions, namely isolation of the bi-directional USB 2 signal interface (USB 2 communication path 110) and isolation of the dual pair of uni-directional USB 3 super speed interface (USB 3 communication path 111). The two bi-directional USB 2 lines 104 and 105 are connected through the USB 2 communication path 110. The four uni-directional USB 3 lines 106-109 are connected through the USB 3 communication path 111.

Since a USB 2 or USB 1 device may be connected to either of the USB 3 devices 102 or 103, the USB 3 standard calls for a step-wise enumeration process for establishing a connection between any two USB devices at the highest speed possible for both devices (low, full, high or super speed). In some embodiments, the USB device automatically recognizes and arbitrates the communication mode. According to this process, when a USB 3 device detects the presence of another USB device (of any standard) the USB 3 device will first attempt to connect at the low speed or full speed through the two bi-directional USB 2 lines (e.g. 104 and 105). If communication is established at full speed, the USB 3 device further attempts to establish communication at the high speed through the two bi-directional USB 2 lines (e.g. 104 and 105). If the other USB device is not capable of the higher speed, then the attempt will fail and the USB 3 device will revert to the full speed communication mode for communicating with this USB device, and the USB 3 device will never get to the point of activating the four uni-directional USB 3 lines (e.g. 106-109). However, if high speed communication succeeds, then communication is established at this speed.

Up to this point, the enumeration process is similar to that for USB 2 devices and has not involved the four uni-directional USB 3 lines (e.g. 106-109). A USB 2 device, therefore, will stop attempting to increase the communication speed at this point since it has reached its maximum speed possible. The USB 3 device, on the other hand, will further attempt to step up to the super speed if a device is detected on the four uni-directional USB 3 lines (e.g. 106-109). However, this step does not go directly to the 5 Gbps rate. Instead, the USB 3 device first attempts, using special information sequences exchanged through the USB 2 portion, to establish a much slower rate of communication (about 10 Mbps) through the four uni-directional USB 3 lines (e.g. 106-109). If the special information sequences exchanged through the USB 2 portion fail to indicate that the attached USB device is compatible with the USB 3 standard, then the USB 3 device reverts to the high speed communication mode on the two bi-directional USB 2 lines (e.g. 104 and 105) for further communication with the other USB device. However, if the special information sequences exchanged through the USB 2 portion indicate that the attached USB device is compatible with the USB 3 standard, then the USB 3 device establishes communication through the four uni-directional USB 3 lines (e.g. 106-109). After the connection at the slower rate succeeds, then the USB 3 device completes the final step up to the super speed communication rate on the four uni-directional USB 3 lines (e.g. 106-109).

As can be seen from the above enumeration process, a proper USB 3 standard design solution must include a proper USB 2 standard solution in order to step up to the super speed communication mode. Similarly, for a USB 3 solution that requires isolation protection, the USB 2 portion of the overall design must also provide isolation protection for all communication modes. Otherwise, unacceptable noise or voltage spikes may be transmitted between the two USB 3 devices through the USB 2 portion. Therefore, the circuitry for the USB 2 communication path 110 generally includes USB 2 isolation circuitry or chip 112, and the circuitry for the USB 3 communication path 111 generally includes USB 3 isolation circuitry 113. At the physical level, the USB 3 super speed interface portion can be seen as being complementary to but independent of the standard USB 2 interface portion.

In some embodiments, circuitry shown in the aforementioned US Patent Publication No. 2014/0211862 may be used for the USB 2 communication path 110, including the USB 2 isolation circuitry 112. Other embodiments may use other appropriate circuitry for enabling isolation protection in the USB 2 communication path 110. In some embodiments, the USB 2 communication path 110 or the USB 2 isolation circuitry 112 may represent a single die or multiple dies inside an IC package and may employ any of the galvanic isolation methods used in digital isolators, e.g. capacitive, inductive, optical, and giant magnetoresistance (GMR).

Additionally, in some embodiments, circuitry shown in the aforementioned U.S. Pat. No. 9,299,655 may be used to provide isolation where appropriate or wherever an isolator chip uses a single die internally. For example, any thick dielectric substrate that is capable of providing the required galvanic isolation may be used. Examples are SOS, SOI, flipped (layer transfer) SOI, etc. The other elements disclosed in this patent application, such as internal ESD protection, broken seal rings, etc., may also apply.

In some embodiments, in addition to the USB 3 isolation circuitry 113, the circuitry for the USB 3 communication path 111 generally includes one or more super speed repeaters or redrivers 114 and 115. The super speed repeaters 114 and 115 are connected on either side of the USB 3 isolation circuitry 113 between the USB 3 isolation circuitry 113 and the four uni-directional USB 3 lines 106-109. The super speed repeaters 114 and 115, thus, serve as communication interfaces that are USB 3 compatible. Additionally, although the super speed repeaters 114 and 115 and the USB 3 isolation circuitry 113 are shown as connected by four uni-directional lines 116-119, similar to the four uni-directional USB 3 lines 106-109, it is understood that the present invention is not necessarily so limited. Instead, any appropriate number and directionality may be used for the lines 116-119, depending on the requirements of the USB 3 isolation circuitry 113.

The super speed repeaters 114 and 115 generally enable compatibility with the USB 3 standard outside of the USB 3 interface circuitry 101 on the four uni-directional USB 3 lines 106-109. In some embodiments, the super speed repeaters 114 and 115 may be any appropriate currently available super speed repeater circuits (e.g. part number MAX14972 commercially available from Maxim Integrated). In other embodiments, the super speed repeaters 114 and 115 may be specially designed (depending on the requirements of the USB 3 isolation circuitry 113) to interface between the USB 3 isolation circuitry 113 and the USB 3 devices 102 and 103 on the uni-directional USB 3 lines 106-109.

The USB 3 isolation circuitry 113 may include any appropriate type of isolation components. In some embodiments, for example, the USB 3 isolation circuitry 113 may include a set of capacitors and additional circuit components that enable passing communication signals in frequency bands that include both of the frequencies (10 Mbps and 5 Gbps) that the uni-directional USB 3 lines 106-109 must be able to handle for complete USB 3 compliance. In some embodiments, at least part of the function of the USB 3 isolation circuitry 113 may be considered to be similar to that of a dual band pass filter, wherein signals within relatively narrow bands around the two desired frequencies are allowed to pass and any signals outside or between those two bands are filtered out. In some embodiments, the signal at one of the two frequencies may be significantly amplified (e.g. with high gain amplifiers) in order to pass through the USB 3 isolation circuitry 113 along with the signal at the other of the two frequencies.

The super speed repeaters 114 and 115 are generally designed to tolerate series capacitors. The data content between USB devices is generally DC-balanced to ensure no net DC voltage across any series capacitors. In some embodiments, this tolerance of series capacitors can be used to isolate the four uni-directional USB 3 super speed lines 106-109 using commercial off-the-shelf (COTS) components. In such embodiments, the super speed repeaters 114 and 115 are used to buffer the super speed signals and apply them across high voltage (e.g. 1-5 kV) isolation capacitors. The super speed repeaters 114 and 115 are needed because simply inserting the isolation capacitors into long super speed cables or communication paths is not likely to work, since high frequency isolation capacitors generally have values in the range of 10-500 pF, whereas the series capacitors used in some super speed lines generally have values of about 100 nF.

Substituting other isolation elements, e.g. transformers or GMR elements, in place of the isolation capacitors might be less likely to work, since super speed interfaces are generally less compatible with the electrical characteristics of those elements. Impedance matching, for example, might be less practical.

In some embodiments, the USB 3 interface circuitry 101 represents a circuit board, and the USB 2 and USB 3 communication paths 110 and 111 represent discrete IC chips mounted on the circuit board. In this case, in some embodiments, the USB 2 communication path 110 may be any appropriate available USB 2 isolation solution, provided it enables isolation protection for all USB 2 communication modes. In some embodiments, the USB 2 communication path 110 or the USB 2 isolation circuitry 112 may represent a single die or multiple dies inside an IC package. In some embodiments, the USB 3 isolation circuitry 113 and the super speed repeaters 114 and 115 of the USB 3 communication path 111 may represent separate IC chips mounted on the circuit board, so that in some embodiments the USB 3 super speed repeaters 114 and 115 may be any appropriate off-the-shelf chips. Alternatively, in some embodiments for cost, size and power reduction, the USB 3 communication path 111 may represent a single self-contained chip (single die or multiple die), rather than a set of chips or off-the-shelf components. In some embodiments, the components for the two different directions through the USB 3 communication path 111 may be separated into different IC chips. This is possible, since there is no special timing synchronization required between the two different direction super speed channels.

In some embodiments, the USB 3 interface circuitry 101 represents a multi-chip IC package, and the USB 2 and USB 3 communication paths 110 and 111 represent two or more IC dies mounted in the multi-chip package. In this case, in some embodiments, the USB 2 communication path 110 may be any appropriate off-the-shelf USB 2 isolation solution. Additionally, the USB 3 communication path 111 may represent one or more IC dies, some of which may be available off-the-shelf.

In some embodiments, the USB 3 interface circuitry 101 represents a single IC chip (single die or multiple die). In this case, the USB 2 and USB 3 communication paths 110 and 111 are more fully integrated into a single solution for better cost, size, performance and power situations.

In some embodiments, one of the USB 3 super speed repeaters 114 and 115 is not included or is optional. This arrangement may be appropriate when the USB 3 isolation circuitry 113 is placed close to (i.e. with an intervening cable or communication line less than 10 cm in length), or in, the host USB 3 device or the attached USB 3 device or an appropriate upstream or downstream portion of a USB 3 hub.

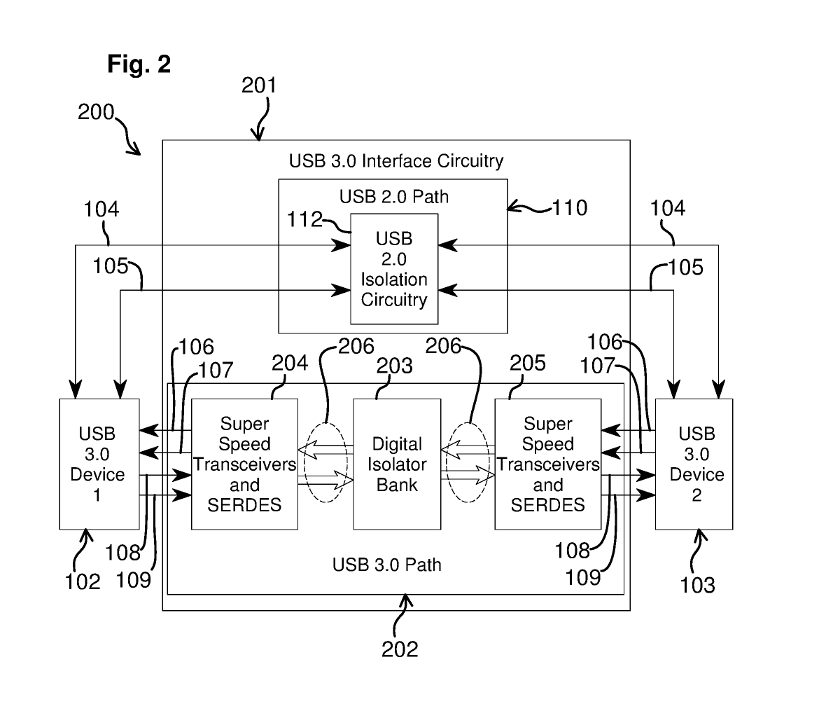

Another electronic system 200 is shown in FIG. 2 in accordance with some alternative embodiments of the present invention. In this case, reference numbers that are the same as those used for elements in previous embodiments may refer to elements that may be the same or generally similar to the corresponding elements in the previous embodiments. Additionally, the electronic system 200 generally includes USB 3 interface circuitry 201 connected between two USB 3 devices 102 and 103. The USB 3 interface circuitry 201 generally connects to the USB 3 devices 102 and 103 through the two bi-directional USB 2 lines 104 and 105 and the four uni-directional USB 3 lines 106-109 in addition to the standard USB power and ground lines (not shown for simplicity). The USB 3 interface circuitry generally enables all modes of USB 2 and 3 communication with isolation protection between the two USB 3 devices 102 and 103. The two USB 3 devices 102 and 103 may be any appropriate electronic devices that are compatible with the USB 3 standard.

The USB 3 interface circuitry 201 generally includes the USB 2 communication path 110 and a USB 3 communication path 202. The USB 2 communication path 110 handles USB 2 standard communications between the USB 3 devices 102 and 103, including the USB 2 standard enumeration process steps described above. The USB 3 communication path 202 generally handles USB 3 standard communications between the USB 3 devices 102 and 103, including the subsequent USB 3 standard enumeration process steps described above. The USB 3 communication path 202 generally includes a digital isolator bank 203 and super speed (LVDS) transceivers and SERDES (serializer/deserializer circuitry) 204 and 205.

Embodiments in accordance with FIG. 2 generally do not rely on high voltage isolation capacitors as described for previous embodiments. Instead, the super speed transceivers and SERDES 204 and 205 are used to receive/transmit the super speed signals at the upstream and downstream sides of the digital isolator bank 203. The digital isolator bank 203 generally includes multiple uni-directional digital isolator channels. The uni-directional digital isolator channels generally convey the signal content across the isolation barrier between the super speed transceivers and SERDES 204 and 205. Since current state of the art digital isolators are generally limited to less than about 640 Mbps per channel, and commercially available digital isolator chips are limited to about 150 Mbps/channel, a single digital isolator channel is generally not capable of handling the full USB 3 standard 5-10 Gbps data rate. Therefore, serialiser-deserialiser (SERDES) functions may be used to convert the serial data on the four uni-directional USB 3 lines 106-109 to parallel data on multiple parallel lines 206 and vice versa. In some embodiments, these functions may be integrated within the super speed transceivers and SERDES 204 and 205 (as shown) or they may reside in separate chips. The parallel data on lines 206 may then feed into as many digital isolators within the digital isolator bank 203 as are needed to enable the full USB 3 standard communication rates.

In some embodiments, the USB 3 interface circuitry 201 represents a circuit board, and the USB 2 and USB 3 communication paths 110 and 202 represent IC chips mounted on the circuit board. In this case, in some embodiments, the USB 2 communication path 110 may be any appropriate available USB 2 isolation solution, provided it enables isolation protection for all USB 2 communication modes. In some embodiments, the USB 2 communication path 110 may represent a single die or multiple dies inside a package. In some embodiments, the digital isolator bank 203 and the super speed transceivers and SERDES 204 and 205 of the USB 3 communication path 202 may represent separate IC chips mounted on the circuit board. Alternatively, in some embodiments for cost, size and power reduction, the USB 3 communication path 202 may represent a single self-contained chip (single die or multiple die), rather than a set of chips or off-the-shelf components. In some embodiments, the components for the two different directions through the USB 3 communication path 202 may be separated into different IC chips. This is possible, since there is no special timing synchronization required between the two different direction super speed channels.

In some embodiments, the USB 3 interface circuitry 201 represents a multi-chip IC package, and the USB 2 and USB 3 communication paths 110 and 202 represent two or more IC dies mounted in the multi-chip package. In this case, in some embodiments, the USB 2 communication path 110 may be any appropriate off-the-shelf USB 2 isolation solution. Additionally, the USB 3 communication path 202 may represent one or more IC dies, some of which may be available off-the-shelf.

In some embodiments, the USB 3 interface circuitry 201 represents a single IC chip (single die or multiple die). In this case, the USB 2 and USB 3 communication paths 110 and 202 are more fully integrated into a single solution for better cost, size, performance and power situations.

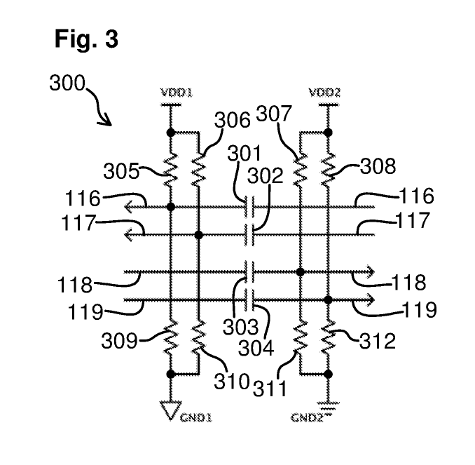

Example USB 3 isolation circuitry 300 that may be used as the USB 3 isolation circuitry 113 in FIG. 1 is shown in FIG. 3. Other designs for USB 3 isolation circuitry may also be used as the USB 3 isolation circuitry 113. The USB 3 isolation circuitry 300, therefore, is shown for illustrative and explanatory purposes only.

In this example, the USB 3 isolation circuitry 300 generally includes four uni-directional high voltage isolation capacitors 301-304 within the uni-directional lines 116-119 and eight resistors 305-312 connected as shown. Downstream nodes of the isolation capacitors 301 and 302 are connected between corresponding resistor pairs 305/309 and 306/310, respectively. Downstream nodes of the isolation capacitors 303 and 304 are connected between corresponding resistor pairs 307/311 and 308/312, respectively. The resistor pairs 305/309 and 306/310 are connected between a first voltage VDD1 and a first ground node GND1 on a first side (downstream to the USB 3 super speed repeater 114) of the isolation capacitors 301 and 302. The resistor pairs 307/311 and 308/312 are connected between a second voltage VDD2 and a second ground node GND2 on a second side (downstream to the USB 3 super speed repeater 115) of the isolation capacitors 303 and 304. The right-to-left uni-directional lines 116 and 117 pass through the isolation capacitors 301 and 302, respectively. The left-to-right uni-directional lines 118 and 119 pass through the isolation capacitors 303 and 304, respectively.

In some embodiments, the isolation capacitors 301-304 are high voltage (e.g. about 1-5 kV) isolation capacitors with capacitance values ranging from less than 1 nF to 100 nF. In such embodiments, the isolation capacitors 301-304 have relatively low ESR (effective series resistance) and relatively low ESL (effective series inductance) to enable passing communications signals at both 10 Mbps and 5 Gbps. In some embodiments, the resistors 305-312 form a network used to improve the differential signal conditions at the receiver inputs of the super speed repeaters 114 and 115 (FIG. 1) in the USB 3 electrical idle state. In such embodiments, the resistors 305-312 generally have about 1% tolerances, resistance values of 5 KΩ or higher, and values needed to maintain the signals on lines 116-119 at about 1V at the receiver inputs of the super speed repeaters 114 and 115.

In addition to the various communication modes and the enumeration process described above, the USB 3 standard specification generally provides for an “active” mode and a “low power” mode, for USB 3 compliant devices (e.g., 102 and 103). In the active mode, the USB 3 device is fully powered up such that it can actively communicate through the USB lines 104-109 with another USB 3 device. In the low power mode, on the other hand, the USB 3 device is not fully powered up. Instead, the USB 3 device is saving power by consuming a low or minimal amount of power and is not currently capable of communicating through the USB lines 104-109. The USB 3 standard specification provides for a USB 3 port to be powered down to conserve power when no other device is attached to it. The USB 3 standard specification further provides for an automatic receiver detect (auto Rx or RX DET) operation during the low power mode. According to the receiver detect operation, a transmitter of the USB 3 device (e.g., the USB 3 compliant devices 102 and 103 and/or the super speed repeaters 114 and 115) continually tests the appropriate USB lines (e.g., 104-109 and/or 116-119) in order to automatically detect when another USB 3 device is connected to it. Upon detecting another USB 3 device, the USB 3 device exits the low power mode and enters the active mode. The USB 3 standard specification calls for disabling the receiver detect feature when the USB 3 device is in active mode, since the receiver detect operation is not needed when the USB 3 device is fully powered up and capable of communicating with any other USB 3 device. The USB 3 standard specification also provides for the ability to disable the receiver detect feature and the low power mode in a design that does not need a power saving feature, so that the USB 3 device always stays in the active mode.

Additionally, the USB 3 standard specification provides for capacitors between USB 3 devices for DC filtering or blocking. These DC block capacitors are specified to be between 75 and 200 nFs and are expected to handle a relatively low voltage. For isolation purposes, however, the capacitors (e.g., capacitors 301-304) must be able to handle a high voltage, e.g., about 1-3 kvolts. At this high voltage level and the 75-200 nF capacitance, the DC block capacitors called for in the USB 3 standard specification would be far too large and potentially dangerous to be practical or appropriate to use. Therefore, the high voltage isolation capacitors (e.g., 301-304), described herein, have a capacitance significantly lower than the 75-200 nF capacitance of the DC block capacitors called for in the USB 3 standard specification. In some embodiments, for example, the high voltage isolation capacitors (e.g., 301-304) have a capacitance no greater than 1-47 nF, i.e., one to two orders of magnitude (or more) lower than that called for in the USB 3 standard specification for DC filtering or blocking, thereby allowing the isolation capacitors (e.g., 301-304) to be an acceptable physical size.

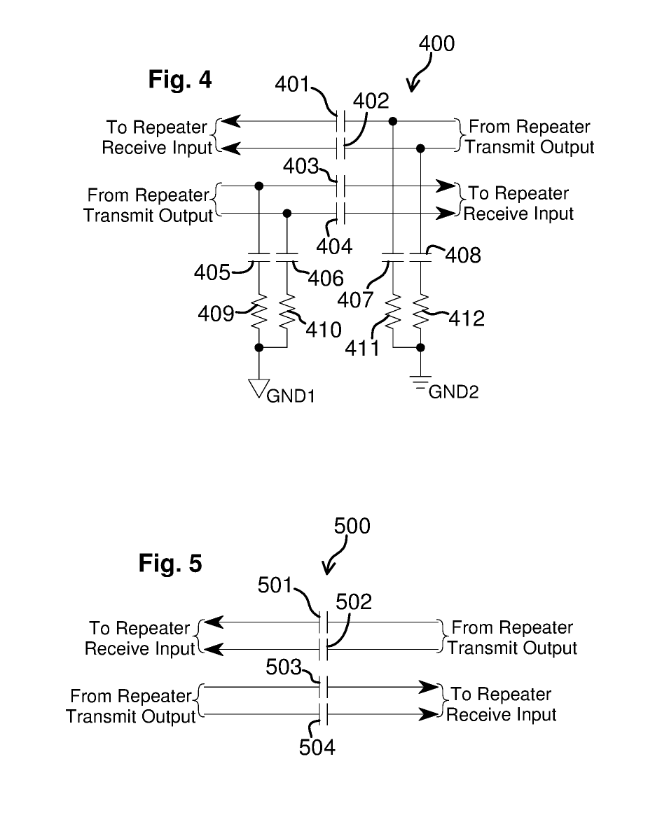

Some currently available super speed repeaters (e.g., 114 and 115) are capable of operating with the USB 3 isolation circuitry 300 shown in FIG. 3. However, other super speed repeaters are incapable of properly performing the receiver detect operation (described above) with the USB 3 isolation circuitry 300, due to the low capacitance of the isolation capacitors 301-304 preventing the transmitters from detecting the attached receivers. Therefore, FIG. 4 shows alternative example USB 3 isolation circuitry 400 that can be used as the USB 3 isolation circuitry 113 in FIG. 1 with these other super speed repeaters, such that the super speed repeaters 114 and 115 can perform the receiver detect operation, even with the relatively low capacitance of isolation capacitors 401-404 connected between the repeater transmit outputs and receive inputs.

In addition to the isolation capacitors 401-404, the USB 3 isolation circuitry 400 generally includes capacitors 405-408 and resistors 409-412. In some embodiments, the isolation capacitors 401-404 are small-capacitance (e.g., less than 1-47 nF), high-voltage (e.g., 1-3 kvolts) capacitors, e.g., the same as or similar to the isolation capacitors 301-304, described above. In some embodiments, the capacitors 405-408 are standard capacitors, i.e., non-high-voltage capacitors, e.g., with a capacitance of about 10 nF. In some embodiments, the resistors 409-412 have a resistance of about 1 kohm.

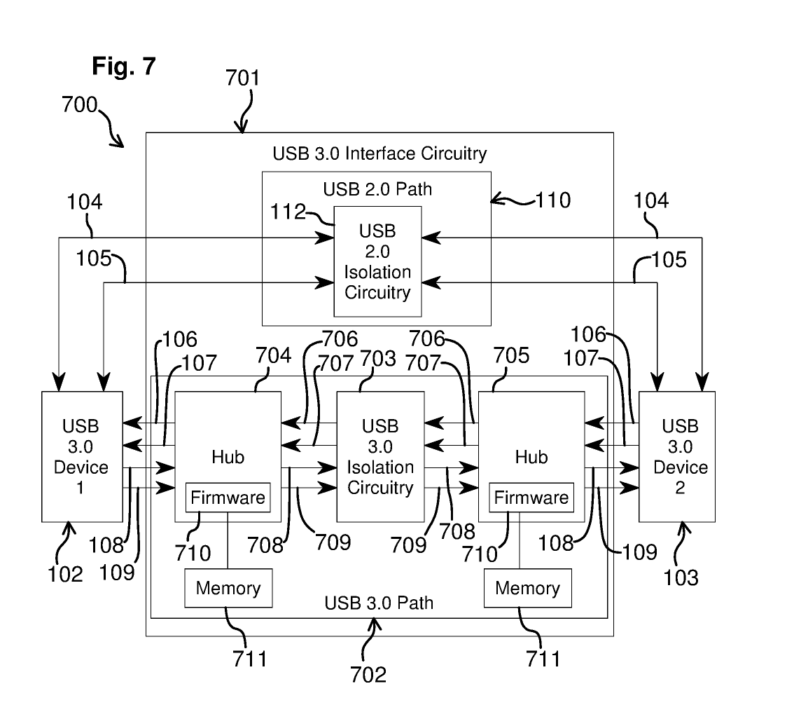

The capacitors 405-408 and resistors 409-412 are connected in pairs (405/409, 406/410, 407/411, 408/412) in series to first and second ground nodes GND1 or GND2 from an upstream node between each repeater transmit output and the isolation capacitor 401-404. Since the isolation capacitors 401-404 are well below the standard 75-200 nF range of the DC block capacitors called for in the USB 3 standard specification, the capacitor/resistor pairs 405-408/409-412 connected to ground GND1 or GND2 generally serve to simulate the presence of a load for the receiver detect operation performed by the super speed repeaters 114 and 115. In this manner, the super speed repeaters 114 and 115 are enabled to pass the standard receiver detect checks that are part of the initial sequence in establishing a super speed link. In some embodiments, additional connections are provided at nodes between the capacitors 405 and 406 and the resistors 409 and 410 through additional resistors (not shown) to VDD1, and further connections are provided at nodes between the capacitors 407 and 408 and the resistors 411 and 412 through additional resistors (not shown) to VDD2. In this manner, the connections through the additional resistors to VDD1 and VDD2 help to stabilize the voltage on the nodes to the capacitors 405-408, thereby allowing the USB 3 isolation circuitry 400 to adapt to different types of USB 3 interfaces in the super speed repeaters or hubs described below with respect to FIGS. 6 and 7.

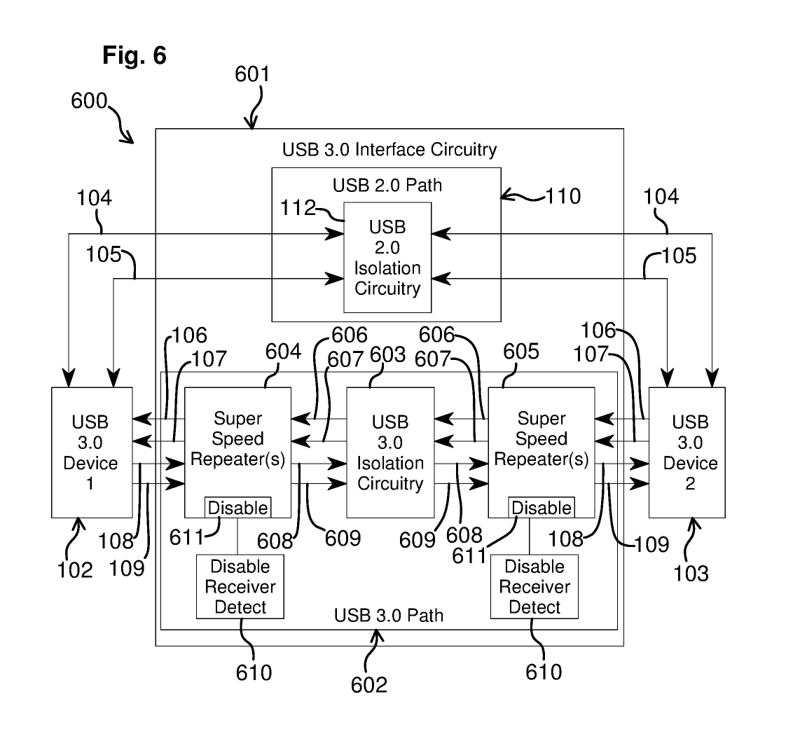

FIG. 5 shows another alternative example USB 3 isolation circuitry 500 in accordance with some embodiments. The USB 3 isolation circuitry 500 generally includes isolation capacitors 501-504 connected between the repeater transmit outputs and receive inputs. In some embodiments, the isolation capacitors 501-504 are similar to the small-capacitance, high-voltage capacitors 301-304 or 401-404 described above. The USB 3 isolation circuitry 500 does not, however, have the resistors 305-312 (FIG. 3) or the capacitor/resistor pairs 405-408/409-412 (FIG. 4). Thus, most super speed repeaters are incapable of properly performing the receiver detect operation (described above) with the USB 3 isolation circuitry 500, due to the low capacitance of the isolation capacitors 501-504 preventing the transmitters from detecting the attached receivers. Therefore, the USB 3 isolation circuitry 500 is generally used in embodiments in which the receiver detect feature has been disabled in the super speed repeaters, as described below.

Another electronic system 600 is shown in FIG. 6 in accordance with some alternative embodiments of the present invention. In this case, reference numbers that are the same as those used for elements in previous embodiments may refer to elements that may be the same or generally similar to the corresponding elements in the previous embodiments. Additionally, the electronic system 600 generally includes USB 3 interface circuitry 601 connected between the two USB 3 devices 102 and 103. The USB 3 interface circuitry 601 generally connects to the USB 3 devices 102 and 103 through the two bi-directional USB 2 lines 104 and 105 and the four uni-directional USB 3 lines 106-109 in addition to the standard USB power and ground lines (not shown for simplicity). The USB 3 interface circuitry 601 generally enables all modes of USB 2 and 3 communication with isolation protection between the two USB 3 devices 102 and 103. The two USB 3 devices 102 and 103 may be any appropriate electronic devices that are compatible with the USB 3 standard.

The USB 3 interface circuitry 601 generally includes circuitry for the USB 2 communication path 110 and a USB 3 communication path 602. The USB 2 communication path 110 handles USB 2 standard communications through the two bi-directional USB 2 lines (104 and 105) between the USB 3 devices 102 and 103, including the USB 2 standard enumeration process steps described above. The USB 3 communication path 602 generally handles USB 3 standard communications through the four uni-directional USB 3 lines (106-109) between the USB 3 devices 102 and 103, including the subsequent USB 3 standard enumeration process steps described above.

In the illustrated embodiment, the USB 3 communication path 602 generally includes USB 3 isolation circuitry 603 and one or more super speed repeaters or redrivers 604 and 605. The super speed repeaters 604 and 605 are connected on either side of the USB 3 isolation circuitry 603 between the USB 3 isolation circuitry 603 and the four uni-directional USB 3 lines 106-109 that connect to other USB 3 devices (e.g., 102 and 103). The super speed repeaters 604 and 605, thus, serve as communication interfaces that are compatible with the USB 3 standard external to the USB 3 interface circuitry 601 on the four uni-directional USB 3 lines 106-109. Additionally, the super speed repeaters 604 and 605 and the USB 3 isolation circuitry 603 are shown as connected by four uni-directional lines 606-609, which may be similar to the four uni-directional lines 116-119, described above, depending on the requirements of the USB 3 isolation circuitry 603.

In some embodiments, the USB 3 isolation circuitry 603 includes any appropriate type of isolation components. In some embodiments, for example, the USB 3 isolation circuitry 603 includes a set of capacitors and additional circuit components that enable passing communication signals in frequency bands that include both of the frequencies (10 Mbps and 5 Gbps) that the uni-directional USB 3 lines 106-109 must be able to handle for complete USB 3 compliance. In some embodiments, the USB 3 isolation circuitry 603 is identical or similar to the example USB 3 isolation circuitry 500 (FIG. 5) described above. In other embodiments, at least part of the function of the USB 3 isolation circuitry 603 may be considered to be similar to that of the example USB 3 isolation circuitry 300 or 400 (FIG. 3 or 4), described above.

For embodiments that use the example USB 3 isolation circuitry 500 for the USB 3 isolation circuitry 603, the relatively small capacitance (e.g., no greater than 1 nF) of the high voltage isolation capacitors 501-504 unexpectedly results in some types of the super speed repeaters 604 and 605 failing to properly perform the receiver detect operation described above. In other words, the super speed repeaters 604 and 605 cannot detect the presence of another USB 3 device under these conditions, so communication is not established. Therefore, the larger (e.g., 75-200 nF) capacitance for the DC block capacitors called for by the USB 3 standard specification, as mentioned above, is generally necessary for the receiver detect operation to be able to reliably detect the presence of the other USB 3 device. (The USB 3 standard specification does not address the issue of isolation.) As explained above, however, to be able to handle high voltage isolation, the DC block capacitors would be impractically large and potentially dangerous. To solve this unexpected problem, the small capacitance isolation capacitors 501-504 are combined with disabling of the receiver detect operation functionality and the low power mode for the super speed repeaters 604 and 605. Therefore, in the illustrated embodiment, the super speed repeaters 604 and 605 are any appropriate currently available super speed repeater circuits that allow for disabling the receiver detect operation.

In the illustrated embodiment, for the purpose of ensuring proper isolation protection, the USB 3 communication path 602 further includes disable receiver detect circuits 610 (one for each super speed repeater 604 and 605), which generate disable signals and provide the disable signals to disable inputs 611 (e.g., a receiver detect enable/disable pin) of the super speed repeaters 604 and 605. In some embodiments, the disable receiver detect circuits 610 include hardwired logic formed in one or more integrated circuits. The super speed repeaters 604 and 605, which are USB 3 compliant devices, disable the receiver detect feature and the low power mode in response to the disable signal, e.g., an appropriate voltage signal held high or low depending on the requirements of the disable inputs 611. The super speed repeaters 604 and 605, therefore, are held in the active mode. Since the receiver detect operation is not needed in the active mode, as mentioned above, the relatively small capacitance of the isolation capacitors 501-504 does not present a problem.

In some embodiments, the USB 3 interface circuitry 601 represents a circuit board, and the USB 2 and USB 3 communication paths 110 and 602 represent discrete IC chips mounted on the circuit board. In this case, in some embodiments, the USB 2 communication path 110 may be any appropriate available USB 2 isolation solution, provided it enables isolation protection for all USB 2 communication modes. In some embodiments, the USB 2 communication path 110 or the USB 2 isolation circuitry 112 may represent a single die or multiple dies inside an IC package. In some embodiments, the USB 3 isolation circuitry 603 and the super speed repeaters 604 and 605 of the USB 3 communication path 602 may represent separate IC chips mounted on the circuit board, so that in some embodiments the USB 3 super speed repeaters 604 and 605 may be any appropriate off-the-shelf chips. Alternatively, in some embodiments for cost, size and power reduction, the USB 3 communication path 602 may represent a single self-contained chip (single die or multiple die), rather than a set of chips or off-the-shelf components. In some embodiments, the components for the two different directions through the USB 3 communication path 602 may be separated into different IC chips.

In some embodiments, the USB 3 interface circuitry 601 represents a multi-chip IC package, and the USB 2 and USB 3 communication paths 110 and 602 represent two or more IC dies mounted in the multi-chip package. In this case, in some embodiments, the USB 2 communication path 110 may be any appropriate off-the-shelf USB 2 isolation solution. Additionally, the USB 3 communication path 602 may represent one or more IC dies, some of which may be available off-the-shelf.

In some embodiments, the USB 3 interface circuitry 601 represents a single IC chip (single die or multiple die). In this case, the USB 2 and USB 3 communication paths 110 and 602 are more fully integrated into a single solution for better cost, size, performance and power situations.

In some embodiments, one of the USB 3 super speed repeaters 604 or 605 is not included or is optional. This arrangement may be appropriate when the USB 3 isolation circuitry 603 is placed close to (i.e. with an intervening cable or communication line less than 10 cm in length), or in, the host USB 3 device or the attached USB 3 device or an appropriate upstream or downstream portion of a USB 3 hub.

Another electronic system 700 is shown in FIG. 7 in accordance with some alternative embodiments of the present invention. In this case, reference numbers that are the same as those used for elements in previous embodiments may refer to elements that may be the same or generally similar to the corresponding elements in the previous embodiments. Additionally, the electronic system 700 generally includes USB 3 interface circuitry 701 connected between the two USB 3 devices 102 and 103. The USB 3 interface circuitry 701 generally connects to the USB 3 devices 102 and 103 through the two bi-directional USB 2 lines 104 and 105 and the four uni-directional USB 3 lines 106-109 in addition to the standard USB power and ground lines (not shown for simplicity). The USB 3 interface circuitry 701 generally enables all modes of USB 2 and 3 communication with isolation protection between the two USB 3 devices 102 and 103. The two USB 3 devices 102 and 103 may be any appropriate electronic devices that are compatible with the USB 3 standard.

The USB 3 interface circuitry 701 generally includes circuitry for the USB 2 communication path 110 and a USB 3 communication path 702. The USB 2 communication path 110 handles USB 2 standard communications through the two bi-directional USB 2 lines (104 and 105) between the USB 3 devices 102 and 103, including the USB 2 standard enumeration process steps described above. The USB 3 communication path 702 generally handles USB 3 standard communications through the four uni-directional USB 3 lines (106-109) between the USB 3 devices 102 and 103, including the subsequent USB 3 standard enumeration process steps described above.

In the illustrated embodiment, the USB 3 communication path 702 generally includes USB 3 isolation circuitry 703 and one or more USB 3 hub circuits 704 and 705. The USB 3 hub circuits 704 and 705 are connected on either side of the USB 3 isolation circuitry 703 between the USB 3 isolation circuitry 703 and the four uni-directional USB 3 lines 106-109 that connect to other USB 3 devices (e.g., 102 and 103). The USB 3 hub circuits 704 and 705, thus, serve as communication interfaces that are compatible with the USB 3 standard external to the

USB 3 interface circuitry 701 on the four uni-directional USB 3 lines 106-109. Additionally, the USB 3 hub circuits 704 and 705 and the USB 3 isolation circuitry 703 are shown as connected by four uni-directional lines 706-709, which may be similar to the four uni-directional lines 116-119, described above, depending on the requirements of the USB 3 isolation circuitry 703.

In some embodiments, the USB 3 isolation circuitry 703 includes any appropriate type of isolation components. In some embodiments, for example, the USB 3 isolation circuitry 703 includes a set of capacitors and additional circuit components that enable passing communication signals in frequency bands that include both of the frequencies (10 Mbps and 5 Gbps) that the uni-directional USB 3 lines 106-109 must be able to handle for complete USB 3 compliance. In some embodiments, the USB 3 isolation circuitry 703 is identical or similar to the example USB 3 isolation circuitry 500 (FIG. 5) described above. In other embodiments, at least part of the function of the USB 3 isolation circuitry 703 may be considered to be similar to that of the example USB 3 isolation circuitry 300 or 400 (FIG. 3 or 4), described above.

For embodiments that use the example USB 3 isolation circuitry 500 for the USB 3 isolation circuitry 703, the relatively small capacitance (e.g., no greater than 1 nF) of the high voltage isolation capacitors 501-504 unexpectedly results in some types of the USB 3 hub circuits 704 and 705 failing to properly perform the receiver detect operation described above. In other words, the USB 3 hub circuits 704 and 705 cannot detect the presence of another USB 3 device under these conditions, so communication is not established. Similar to the embodiment described above for FIG. 6, to solve the unexpected problems associated with using small-capacitance, high-voltage capacitors, the isolation capacitors 501-504 are combined with disabling of the receiver detect operation functionality and the low power mode for the USB 3 hub circuits 704 and 705. Therefore, in the illustrated embodiment, the USB 3 hub circuits 704 and 705 are any appropriate currently available USB 3 hub circuits that allow for disabling the receiver detect operation.

Additionally, each USB 3 hub circuit 704 and 705 is a programmable device that includes firmware 710 that controls their operation. Furthermore, the USB 3 hub circuits 704 and 705 operate with corresponding memory units 711 (e.g., one for each USB 3 hub circuit 704 and 705) that store configuration data for configuring or programming the firmware 710 at power up of the USB 3 hub circuits 704 and 705. In some embodiments, the memory units 711 are EPROMs (erasable programmable read-only memory devices), other nonvolatile flash-type memory devices, or field programmable devices. During manufacturing of the USB 3 interface circuitry 701 or the USB 3 communication path 702, for the purpose of ensuring proper isolation protection, the memory units 711 are flashed or loaded with configuration data that includes data, instructions or a program that will disable the receiver detect operation functionality of the USB 3 hub circuits 704 and 705. During operation, therefore, the USB 3 hub circuits 704 and 705 read the configuration data into the firmware 710 from the memory units 711 (e.g., through a serial port) at power up and disable the receiver detect feature and the low power mode in accordance with the instructions. The USB 3 hub circuits 704 and 705, thus, are held in the active mode. Since the receiver detect operation is not needed in the active mode, as mentioned above, the relatively small capacitance of the isolation capacitors 501-504 does not present a problem.

In some embodiments, each memory unit 711 is a small IC chip typically mounted on the same circuit board or substrate as an IC chip for the corresponding USB 3 hub circuit 704 or 705. In other embodiments, each USB 3 hub circuit 704 and 705 has its own memory unit 711 built-in to its IC chip.

In some embodiments, the USB 3 interface circuitry 701 represents a circuit board, and the USB 2 and USB 3 communication paths 110 and 702 represent discrete IC chips mounted on the circuit board. In this case, in some embodiments, the USB 2 communication path 110 may be any appropriate available USB 2 isolation solution, provided it enables isolation protection for all USB 2 communication modes. In some embodiments, the USB 2 communication path 110 or the USB 2 isolation circuitry 112 may represent a single die or multiple dies inside an IC package. In some embodiments, the USB 3 isolation circuitry 703 and the USB 3 hub circuits 704 and 705 of the USB 3 communication path 702 may represent separate IC chips mounted on the circuit board, so that in some embodiments the USB 3 hub circuits 704 and 705 may be any appropriate off-the-shelf chips. Alternatively, in some embodiments for cost, size and power reduction, the USB 3 communication path 702 may represent a single self-contained chip (single die or multiple die), rather than a set of chips or off-the-shelf components. In some embodiments, the components for the two different directions through the USB 3 communication path 702 may be separated into different IC chips.

In some embodiments, the USB 3 interface circuitry 701 represents a multi-chip IC package, and the USB 2 and USB 3 communication paths 110 and 702 represent two or more IC dies mounted in the multi-chip package. In this case, in some embodiments, the USB 2 communication path 110 may be any appropriate off-the-shelf USB 2 isolation solution. Additionally, the USB 3 communication path 702 may represent one or more IC dies, some of which may be available off-the-shelf.

In some embodiments, the USB 3 interface circuitry 701 represents a single IC chip (single die or multiple die). In this case, the USB 2 and USB 3 communication paths 110 and 702 are more fully integrated into a single solution for better cost, size, performance and power situations.

In some embodiments, one of the USB 3 hub circuits 704 or 705 is not included or is optional. This arrangement may be appropriate when the USB 3 isolation circuitry 703 is placed close to (i.e. with an intervening cable or communication line less than 10 cm in length), or in, the host USB 3 device or the attached USB 3 device or an appropriate upstream or downstream portion of a USB 3 hub.

Although embodiments of the present invention have been discussed primarily with respect to specific embodiments thereof, other variations are possible. Various configurations of the described system may be used in place of, or in addition to, the configurations presented herein.

Those skilled in the art will appreciate that the foregoing description is by way of example only, and is not intended to limit the present invention. Nothing in the disclosure should indicate that the present invention is limited to systems that require a particular form of semiconductor processing or to integrated circuits. In general, any diagrams presented are only intended to indicate one possible configuration, and many variations are possible. Those skilled in the art will also appreciate that methods and systems consistent with the present invention are suitable for use in a wide range of applications.

While the specification has been described in detail with respect to specific embodiments of the present invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims.

What is claimed is:

1. An electronic circuit comprising:
first and second communication interfaces that are USB 3 compatible; and
isolation circuitry between the first and second communication interfaces;
wherein the isolation circuitry is compatible with all USB 3 communication modes.

2. The electronic circuit of claim 1, further comprising:
a means for disabling a receiver detect feature in the first and second communication interfaces.

3. The electronic circuit of claim 1, further comprising:
third and fourth communication interfaces that are USB 2 compatible and mounted with the first and second communication interfaces; and
second isolation circuitry between the third and fourth communication interfaces;
wherein the second isolation circuitry is compatible with all USB 2 communication modes.

4. The electronic circuit of claim 1, wherein the isolation circuitry comprises:
isolation capacitors; and
series capacitor/resistor pairs corresponding to the isolation capacitors;
wherein:
the isolation capacitors are within uni-directional communication lines between the first and second communication interfaces; and
upstream nodes of the isolation capacitors are connected through the series capacitor/resistor pairs and one or more ground voltage nodes.

5. The electronic circuit of claim 1, wherein the isolation circuitry comprises:
isolation capacitors; and
resistor pairs corresponding to the isolation capacitors;
wherein:
the isolation capacitors are within uni-directional communication lines between the first and second communication interfaces; and
downstream nodes of the isolation capacitors are connected between the corresponding resistor pairs to one or more VDD voltage nodes and one or more ground voltage nodes.

6. An electronic circuit comprising:
first and second serial communication interfaces; and
isolation circuitry between the first and second serial communication interfaces;
wherein the isolation circuitry operates at two different communication frequency levels.

7. The electronic circuit of claim 6, wherein
the first and second serial communication interfaces are USB 3 compatible; and
the isolation circuitry is compatible with all USB 3 communication modes.

8. The electronic circuit of claim 7, further comprising:
a means for disabling a receiver detect feature in the first and second serial communication interfaces.

9. The electronic circuit of claim 7, further comprising:
third and fourth serial communication interfaces that are USB 2 compatible and mounted with the first and second serial communication interfaces; and
second isolation circuitry between the third and fourth serial communication interfaces;
wherein the second isolation circuitry is compatible with all USB 2 communication modes.

10. The electronic circuit of claim 6, wherein the isolation circuitry comprises:
isolation capacitors; and
series capacitor/resistor pairs corresponding to the isolation capacitors;
wherein:
the isolation capacitors are within uni-directional communication lines between the first and second communication interfaces; and
upstream nodes of the isolation capacitors are connected through the series capacitor/resistor pairs and one or more ground voltage nodes.

11. The electronic circuit of claim 6, wherein the isolation circuitry comprises:
isolation capacitors; and
resistor pairs corresponding to the isolation capacitors;
wherein:
the isolation capacitors are within uni-directional communication lines between the first and second serial communication interfaces; and
downstream nodes of the isolation capacitors are connected between the corresponding resistor pairs to one or more VDD voltage nodes and one or more ground voltage nodes.

12. The electronic circuit of claim 6, wherein one of the two different communication frequency levels is at about 5 Gbps.

13. The electronic circuit of claim 6, wherein the two different communication frequency levels include a first communication frequency level of about 10 Mbps and a second communication frequency level of about 5 Gbps.

14. A method comprising:
receiving a first serial communication at a first frequency;
transmitting the first serial communication through isolation circuitry;
receiving a second serial communication at a second frequency greater than the first frequency; and
transmitting the second serial communication through the isolation circuitry;
wherein the isolation circuitry provides galvanic isolation at both the first and second frequencies.

15. The method of claim 14, wherein:
the first and second serial communications are USB 3 compatible; and
the isolation circuitry is compatible with all USB 3 communication modes.

16. The method of claim 15, further comprising:
disabling a receiver detect feature of a USB 3 device that receives and transmits the first and second serial communications.

17. The method of claim 15, further comprising:
receiving a third serial communication that is USB 2 compatible; and
transmitting the third serial communication through second isolation circuitry that is compatible with all USB 2 communication modes and mounted with the first isolation circuitry.

18. The method of claim 14, wherein the isolation circuitry comprises:
isolation capacitors; and
series capacitor/resistor pairs corresponding to the isolation capacitors;
wherein:
the isolation capacitors are within uni-directional communication lines between first and second serial communication interfaces; and
upstream nodes of the isolation capacitors are connected through the series capacitor/resistor pairs and one or more ground voltage nodes.

19. The method of claim 14, wherein the isolation circuitry comprises:
isolation capacitors; and
resistor pairs corresponding to the isolation capacitors;
wherein:
the isolation capacitors are within uni-directional communication lines between first and second serial communication interfaces; and
downstream nodes of the isolation capacitors are connected between the corresponding resistor pairs to one or more VDD voltage nodes and one or more ground voltage nodes.

20. The method of claim 14, wherein the first frequency is at about 5 Gbps.

21. The method of claim 20, wherein the second frequency is at about 10 Gbps.
